(19) United States
(12) Patent Application Publication
(10) Pub. No.: US 2014/0211929 A1
(43) Pub. Date: Jul. 31, 2014

(54) METHOD AND APPARATUS FOR IDENTIFYING AND MANAGING PARTICIPANTS IN A CONFERENCE ROOM

(71) Applicant: AVAYA INC., Basking Ridge, NJ (US)

(72) Inventors: Parameshwaran Krishnan, Basking Ridge, NJ (US); Navjot Singh, Denville, NJ (US)

(73) Assignee: AVAYA INC., Basking Ridge, NJ (US)

(21) Appl. No.: 13/753,171

(22) Filed: Jan. 29, 2013

(51) Int. Cl. H04M 3/42

(52) U.S. Cl. CPC H04M 3/42059
USPC 379/142.04

(57) ABSTRACT

Systems and methods for identifying participants present in a communication session are disclosed. More particularly, the identification of participants using a shared communication endpoint is enabled. Identification can include receiving information from a first participant that identifies a second participant. The identification of the second participant can include receiving a selection of the second participant from a list of expected conference participants presented to the first participant through a communication device associated with the first participant, after the first participant has been registered as a participant in the communication session.

### FIELD

Systems and methods for identifying conference participants at a communication endpoint are provided.

### BACKGROUND

During a multi-party teleconference (hereinafter “conference”), it is desirable to provide an indication of the identity of the persons who are currently participating in the conference. This is easily managed when each participant has his or her own individual communication device. For example, the “caller ID” or similar identifier of the speaker's communication device can be used to provide an indication to other participants of the speaker's identity.

A problem arises when two or more people share a conference endpoint, such as a speakerphone, as is commonly found in a conference room. In particular, it can be difficult for the conference system to determine the identities of those persons actually participating in the conference through a shared endpoint. This can present problems, as many advanced features of conference systems depend on having available the identities of conference participants. For example, such information is necessary in determining whether a quorum is present, identifying and finding missing participants, managing the agenda, etc.

In order to identify participants at a shared conference endpoint, various techniques have been proposed. For example, voice print identification, facial recognition, or other biometric techniques can be applied. However, such approaches can be expensive to implement, undesirably slow, and prone to recognition errors. Other techniques require that participants carry special locating equipment on their person that can be detected by the conference system. As yet another approach, roll calls of participants can be taken. However, roll calls are time consuming, can interrupt the flow of the conference, and do not account for changes in the roster during the conference.

### SUMMARY

Systems and methods for identifying multiple users of a single conference endpoint are provided. More particularly, a participant self-identifies their presence at a conference endpoint and registers with the conference system, for example, by associating their personal user device, such as but not limited to a smartphone, with the conference endpoint. In addition, a participant who is registered with the conference system can provide information that identifies other participants at the conference endpoint to the conference system. Accordingly, a complete roster of participants sharing a single endpoint can be created.

Systems in accordance with the present disclosure include a conference server component that provides conventional conference facilities, including support for voice, video, and/or data communications between multiple endpoints. In addition to the conventional conference facilities, embodiments of the present disclosure provide a registration feature, which allows individual participants to register with the system and indicate their participation in a conference through a particular endpoint. A registered participant can also identify other participants to the conference system. Such identification of other participants can be facilitated by providing registered participants with a list of other expected participants. Based on the information regarding registered participants and other participants identified by registered participants, a roster of participants can be maintained by the system. This roster can in turn be used to support various conference system features, such as but not limited to determining whether a quorum is present, identifying and finding missing participants, and agenda management.

The system features can be provided using application programming executed by a processor capable of receiving participant identification information, either through registrations of individual participants or through the identification of other participants by a registered participant, and of using such information to generate a roster of participants. The system features can further be implemented in connection with an application that can be executed by a user device that is in communication with the conference server. An application on a user device can include, as examples but without limitation, a browser or other general application that supports communications with the conference server, or a specially developed application or app that supports communications and that itself provides an interface to the server system.

Methods in accordance with embodiments of the present disclosure include registering a conference participant at a first conference endpoint with a conference system. In addition, a registered participant can identify other participants to the conference system through an interface with the conference system. The conference system can therefore build a roster of conference participants who are currently present. The methods can additionally include provisions for validating information received from registered participants about other participants. For example, identification by multiple registered participants, by one or more registered participants holding certain credentials, or by registered participants who have been confirmed as actually being at the location of the conference endpoint for which that registered participant is offering information identifying other participants may be required. Requests to update or confirm the identities of participants can also be made to registered participants.

Additional features and advantages of embodiments of the present disclosure will become more readily apparent from the following discussion, particularly when taken together with the accompanying drawings.

### BRIEF DESCRIPTION OF THE DRAWINGS

FIG. 1 illustrates components of a communication system in accordance with embodiments of the present disclosure;

FIG. 2 depicts components of a communication server in accordance with embodiments of the present disclosure;

FIG. 3 depicts components of a communication device and/or a user device in accordance with embodiments of the present disclosure; and

FIG. 4 is a flowchart depicting aspects of a method in accordance with embodiments of the present disclosure.

### DETAILED DESCRIPTION

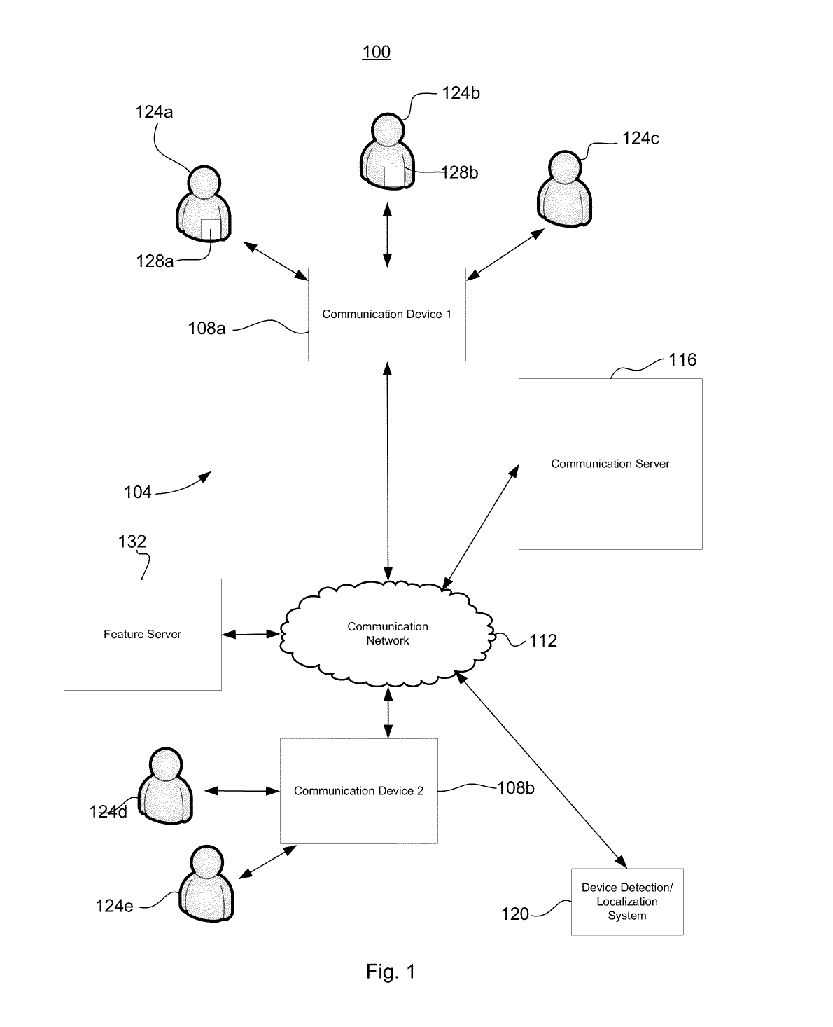

FIG. 1 is an illustration of a communication system 100 having a conference call system 104 incorporating participant identification features in accordance with embodiments of the present disclosure. The communication system 100 generally includes the conference call system 104 and a plurality of communication devices or endpoints 108. For example, a first communication device 108a can be provided as part of the conference call system 104, and a second communication device 108b can be provided that is capable of communicating with the first communication device 108a via one or more communication networks 112. The communication system 100, and in particular the conference call system 104, can additionally include a communication or conference server 116. Some or all of the communication devices 108 can be associated with one or more users 124 and can therefore operate as a shared communication device. For example, the first communication device 108a can be associated with a plurality of users 124a-c. Moreover, in this example the second communication device 108b is associated with two users, 124d and 124e. However, as can be appreciated by one of skill in the art after consideration of the present disclosure, a communication device 108 can be associated with any number of users 124. Some or all of the users 124 can be associated with one or more user devices, 128a and 128b. The communication system 100 can also include one or more feature servers 132.

A communication device 108 in accordance with embodiments of the present disclosure can comprise any communication device or endpoint capable of supporting audible (e.g., voice) communications in association with one or more users 124. Accordingly, a communication device 108 may comprise a telephone, a speaker phone, a conference room communication system, a cellular telephone, a smartphone, a softphone, or the like. Moreover, in accordance with still other embodiments, a communication device 108 can support communications that are other than audible communications. For example, a communication device 108 can provide video, instant messaging, short message service, email, or other communication capabilities. As further examples, a communication device 108 can provide connectivity to registration and or control functions of the communication server 116 of the conference call system 104 as described herein.

The communication devices 108 are generally capable of communicating with one another, or with other communication devices 108 or server devices 116, across or in association with the communication network 112. The communication network 112 may comprise a packet data network, such as a local area network (LAN) and/or a wide area network (WAN). Alternatively or in addition, the communication network 112 may comprise a dedicated connection between two or more communication devices 108. In accordance with still other embodiments, the communication network 112 may comprise a circuit based communication network. As examples, but without limitation, the communication network 112 can comprise the public internet, a private intranet, the public switched telephone network (PSTN), a cellular telephony network, a satellite telephone network, etc. Furthermore, the communication network 112 may include any number of different network types in various combinations. Moreover, the network 112 can use a variety of protocols, alone or in combination, such as Ethernet, Internet Protocol (IP), Session Initiation Protocol (SIP), Integrated Services Digital Network (ISDN), and the like.

The communication server 116 may comprise a general purpose computer or server capable of providing various services or functions in connection with the operation of one or more of the communication devices 108. In an exemplary embodiment, the communication server 116 may comprise an enterprise telecommunications server providing a conference bridge, private branch exchange (PBX), sequenced application, or other services, in addition to operating in connection with the identification of conference participants or users 124 at a shared communication endpoint 108 as described herein. Moreover, the communication server 116 may be incorporated into and/or may comprise one or more communication devices 108.

A user device 128 may comprise a communication device that is associated with a particular user. Examples of a user device 128 therefore include, but are not limited to, a cellular telephone, a smartphone, a two-way pager, a tablet computer, a laptop computer, or the like. Moreover, a user device can be operated as a communication device 108 that participates as an endpoint in a conference or other conference system 104 as described herein. In accordance with still other embodiments, a user device 128 is not required to provide two-way communications capabilities. For example, a user device can include an RFID (radio frequency identification) tag, an optically readable identification tag, etc.

In general, the system 100 supports communications between users 124. In particular, the system 100 operates to identify a user 124 participating in a conference implemented in connection with a conference system 104, even where multiple users 124 are sharing a single communication device or endpoint 108. Moreover, the system 100 can function by soliciting or inviting input from a user 124 who has indicated their presence by registering with the conference system to identify other users 124 participating in the conference. This information can be used to support advanced conference call features, such as confirming that a quorum of users 124 is present on a call/conference, locating missing participants, managing an agenda, and the like.

Additionally, a device detection and localization system 120 may be used by participants 124 entering a room with a conference to self-identify. A code may be available from the shared communication endpoint 108. The reading in of the code by the user device 128 can create a locational association of the two devices 108, 128, indicating to the conference session that the two devices 108, 128 are in close proximity. The user device 128 may then use the device detection and localization system 120 for check-in once the locational association with the shared communication endpoint 108 has been established. The device detection and localization system 120 might include, but is not limited to a Quick Response (QR) code reader, a bar code reader, a GPS, an RFID tag reader, DTMF and/or telephony capability, a optical key system, and the like.

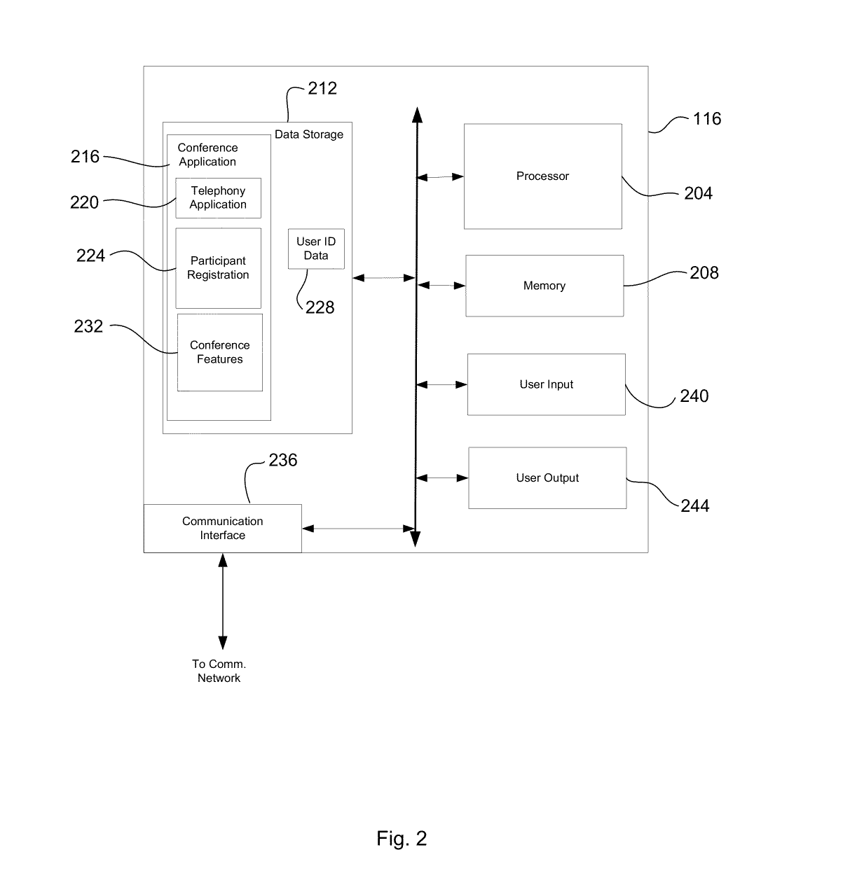

FIG. 2 illustrates aspects of the communication server 116 of a conference call system 104 in accordance with embodiments of the present disclosure. In general, the communication server 116 may be implemented, as a conventional computing device. Accordingly, the communication server 116 generally includes a processor 204 capable of executing program instructions. The processor 204 may include any general purpose programmable processor or controller for executing application programming. Alternatively, the processor 204 may comprise a specially configured application specific integrated circuit (ASIC). The processor 204 generally operates to run programming code implementing various functions performed by the associated communication server 116 and/or associated devices or systems, including but not limited to a communication device 108 and/or a device detection and localization system 120. For example, the processor 204 can implement functions supporting voice and/or multimedia communications in association with an interconnected communication device 108. Moreover, such functions can include the receipt, storage, and maintenance of information identifying actual participants 124 in a conference, including of information from one participant 124 that identifies another participant 124 at a shared communication endpoint 108.

The communication server 116 additionally includes memory 208. The memory 208 can be used in connection with the execution of programming by the processor 204, and for the temporary or long term storage of data and/or program instructions. As examples, the memory 208 may comprise a computer readable medium, such as RAM, SDRAM, or other solid state memory. Alternatively or in addition, data storage 212 may be provided. In accordance with embodiments of the present disclosure, the data storage 212 can contain programming code or instructions implementing various applications or functions executed or performed by the communication server 116. Like the memory 208, the data storage 212 may comprise a computer readable memory, such as RAM, SDRAM, or other solid state memory. Alternatively or in addition, the data storage 212 may comprise a computer readable medium such as a hard disk drive or other random access memory.

In accordance with embodiments of the present disclosure, the data storage 212 can include various applications and data. For example, the data storage 212 can include a conference application 216, the execution of which by the processor 204 implements various standard and advanced conference call functions, including calendaring functions, the initiation of a communication channel to a communication device 108 associated with one or more users 124, the maintenance of a conference agenda, and the like. The conference application 216 can include various sub-applications or modules. For example, the conference application 216 can include a telephony application or module 220. The telephony application 220 can generally operate to support voice communications between communication devices 108. Alternatively or in addition, the telephony application 220 can comprise a video telephony application, to support the exchange of multimedia communication streams between communication endpoints 108. A participant registration application or module 224 can also be included in the conference application 216. The participant registration application 224 generally operates to control and/or provide support for the tracking of users 124 participating in a conference call. More particularly, the participant registration application 224 can function to allow a user 124 to register with the participant registration application 224 and to identify other users 124 at a shared communication endpoint 108. Registration of a user 124 can include providing the participant registration application 224 with signals indicating the presence of a device 128 associated with a particular user 124 in the proximity of a communication device 108 operating as an endpoint to a conference call supported by the conference application 216. Alternatively or in addition, registration can include a user 124 using the device detection and localization system 120 or self-identifying to the participant registration application 224 through an interface provided by a user device 128, a communication endpoint 108, or some other device in communication with the communication server 116. A conference features application or module 232 can also be included as part of the conference application 216. The conference features application 232 can operate to provide the standard or advanced conference features of the conference application 216.

The communication server 116 can additionally include a communication interface 236. The communication interface can operate to interconnect the communication server 116 to one or more communication devices 108, and one or more user devices 128 or other system components directly or through the communication network 112. Moreover, such interconnections can be through a single port, such as an Internet Protocol (IP) port, and/or through multiple ports or interfaces. The communication server 116 can additionally include a user input device 240, such as a keyboard, microphone, mouse, or other input device, and a user output device 244, such as a display, speaker, or other output device.

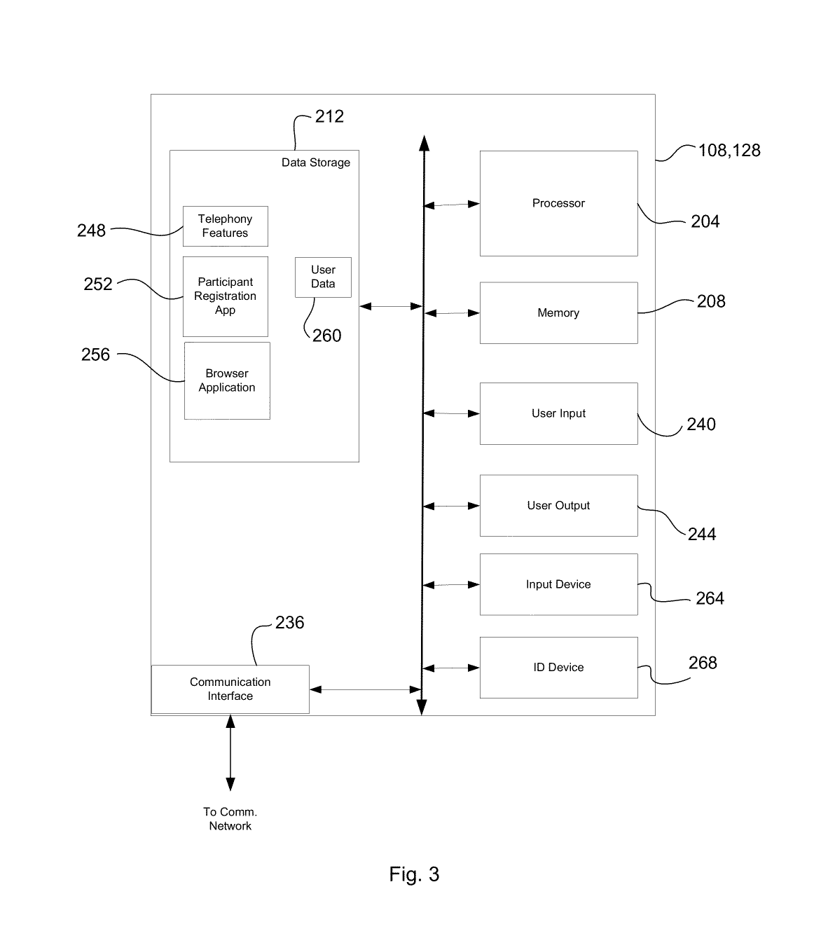

With reference now to FIG. 3, components of a communication device 108 and/or a user device 128 in accordance with embodiments of the present disclosure are illustrated. More particularly, the device 108, 128 can be implemented, at least partially, as a smartphone, or as a softphone running on a computing device, such as but not limited to a tablet, laptop, or desktop computer. Accordingly, the device 108, 128 can include a processor 204, memory 208 and data storage 212, as described in connection with the communication server 116. The applications and data maintained or stored in the data storage 212, however, will generally differ from that stored in the communication server 116. For example, the data storage 212 in a device 108, 128 can include telephony features 248 that enable the device 108, 128 to function as a voice and/or video telephony endpoint. The data storage 212 can additionally include a participant registration app 252. As described in greater detail elsewhere herein, a participant registration app 252 can facilitate the registration of a user 124 with the participant registration application or module 224 of the conference application 216, and the identification of additional participants 124 sharing an endpoint 108, as described herein. A further example of an application that can be stored in data storage 212 of a device 108, 128 is a browser application 256. In addition to supporting general web browsing activities, a browser application 256 can be used to register and/or identify participants 124 at an endpoint 108 participating in a conference supported by the communication server 116. In addition, user data 260, such as contacts, calendars, and other information personal to a user of the device 108, 128 can be stored.

The device 108, 128 can also include a communication interface 236. The communication interface 236 can operate to interconnect the device 108, 128 to one or more other communication devices 108 and/or the communication server 116, either directly or through the communication network 112. As examples, the communication interface 236 can include any wired or wireless interface, such as but not limited to a cellular telephony transceiver, a Wi-Fi transceiver, an Ethernet card, a Bluetooth interface, etc.

A device 108, 128 also generally includes one or more user input devices 240, such as a keyboard, keypad, microphone, mouse, biometric input device, or the like. A device 108, 128 can also include one or more additional input devices 264, such as but not limited to a camera, optical scanner, magnetic card reader, radio frequency identification device reader, or the like. In accordance with at least some embodiments, an input device 264 may comprise or operate in connection with a communication interface 236. For example, an input device 264 can include a near field communications system, a radio frequency identification system, a Bluetooth interface, an infrared interface, or the like. A device 108, 128 can also include various user output devices 244, such as a display, speaker, vibrator, indicator lamp, or the like. In addition, various identification devices 268 can be associated with or included in a device 108, 128. Examples of identification devices 268 include radio frequency identification tags, near field communication or other radio frequency identifiers, barcodes, quick response codes, and the like.

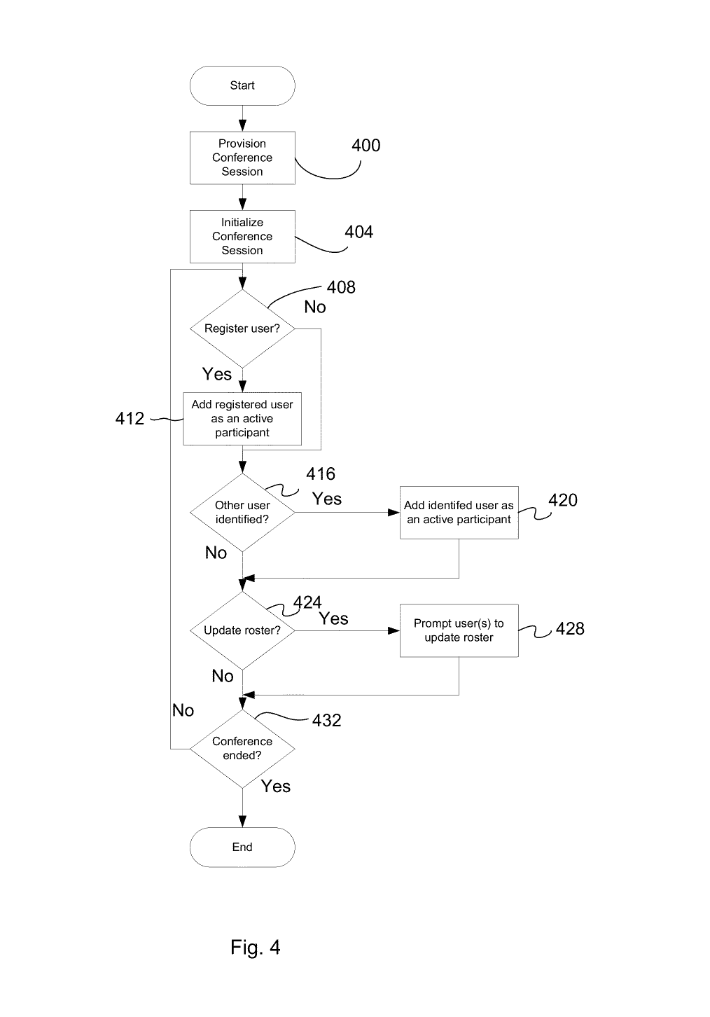

With reference now to FIG. 4, aspects of the operation of a conference call system 104 in accordance with embodiments of the present disclosure are illustrated. Initially, at step 400, a conference session is provisioned. This can include interfacing with a conference application 216 executed by a conference server 116 to provide the conference application 216 with various conference parameters. Such conference parameters can include, but are not limited to scheduled day and start time, a list of participants, and contact information for the participants. Other information regarding a conference that can be provisioned as part of this step can include a conference agenda, required participants, supporting documentation or files, and conference facility reservations.

After provisioning the conference session, the conference session can be initiated (step 404). This can include placing calls to or otherwise establishing a communication channel with conference endpoints 108. Initiation of the conference session can be performed automatically, for example through operation of the conference application 216 in connection with provisioned conference parameters. Alternatively, a conference can be initiated manually. At step 408, a determination is made as to whether a user has registered as an active participant. In accordance with embodiments of the present disclosure, a user can register as an active participant by interfacing with a device detection and localization system 120 by an input device 264 of a device 108, 128. Identifying information can be obtained by scanning an RFID tag, optical tag, magnetic card, sound/ultrasound from a speaker and/or a microphone, or other information. For example, a unique code might be provided to the device 108, read into the device 128, and processed for registration. The reading in of the code by the device 128 can create a locational association of the two devices 108, 128, indicating to the conference session that the two devices 108, 128 are registered and in close proximity. A user can also register as an active participant by interfacing with the conference application 216, and in particular with a participant registration function or module 224 of the conference application 216.

Interactivity between a user 124 and the conference application 216 can be supported through a user input 240 and user output 244 provided by the conference server 116 and/or a communication device 108 or 128. Moreover, such interactivity can be supported through a general or specially developed application. For instance, a user 124 may interface with the conference application 216 by pointing a browser application 256 running on a conference device 108 or 128 to the conference server 116. Moreover, pointing a browser application 256 to the conference server 116 can include manual entry of a URL, or through reading a quick response code or otherwise providing a device 108 or 128 with the address information necessary to point the browser application 256 to the conference server 116. In accordance with still other embodiments, a device 108 or 128 can execute a participant registration app or application 252 that provides an interface between a user 124 and the conference application 216. As can be appreciated by one of skill in the art after consideration of the present disclosure, a participant registration app 252 can itself provide connectivity features, or can operate in connection with a browser application 256 or other application. Registration can additionally include the user 124 providing identification information to the conference application 216. Such information can be manually entered, for example through a user input 240. Alternatively or in addition, identifying information can be provided from, for example, stored user data 260. As yet another example, an ID device 268, for example included as part of or associated with a user device 128 can serve to uniquely identify the associated user 124 to the conference application 216, which can then access user ID data 228 stored on or associated with the conference server 116 to identify the user 124.

At step 412, the registered user 124 can be added as an active participant to the roster of participants for the communication session. At step 416, a determination can be made as to whether another user 124 has been identified. In particular, a determination is made as to whether a registered user 124 has identified any other user as being present at a shared communication endpoint 108. In accordance with embodiments of the present disclosure, a registered user 124 can identify other participants 124 by interfacing with the conference application 216, and in particular the participant registration module or function 224 associated with the conference application 216. In an exemplary embodiment, a registered user 124 can identify another user or participant 124 by selecting that other user's name from a list presented by a user interface, for example provided by a participant registration application 252 and/or a browser application 256 and a user output 244 of a communication device 108 or 128. For example, a list of expected participants 124 can be presented, and one or more participants 124 can be identified as present through an input made by the registered user 124. As another example, a registered user 124 can manually enter information identifying the other participant 124 in the user interface provided by an app 252 or browser 256. Accordingly, the process can be the same or similar to the process for initially registering a user 124, except that embodiments of the present disclosure enable the identification of other users 124 by previously registered users 124. At step 420, the identified user 124 is added as an active participant. The identification of other users 124 by previously registered users 124 at a communication device 108 may also inform the communication server 116 that the communication device 108 is a shared device. The shared nature of the communication device 108 may be presented via the participant registration application 252 and/or the browser application 256. The presentation of the shared nature of the communication device 108 may assist in identification of multi-user endpoints 108 in conference rooms.

Information entered by a registered user 124 typically would be sufficient to verify user identity. In cases where the information is not sufficient, the communication server 116 may optionally include a reconciliation algorithm that may be executed by the participant registration module 224 to authenticate the identified user 124. A threshold (e.g., 3) of positive identifications may be used to determine authenticity. Weights may be assigned based on the confirmation of a user's location (e.g., using GPS coordinates) and additional input. Other media, including pictures, audio clips, and the like could be used to authenticate the identified user 124. Any of the techniques described (e.g., thresholds, weights, other media, etc.) might be used to identify the current speaker in a conference in real-time and post-conference. A confidence rating may be used to determine the location and the identified owner 124 of the user device 108, 128 who provided the information.

At step 424, a determination can be made as to whether the roster of active participants should be updated. If an update is indicated, for example because a predetermined period of time has expired since information identifying users 124 was last received, a user or users 124 may be prompted to update the roster (step 428). For example, a user 124 can, through a user interface presented by a participant registration app 252 and/or a browser application 256, be asked to confirm the presence of previously identified users 124, indicate any changes in the identities of participating users 124, determine a confidence rating, and/or check the list of users 124 participating in the conference, as maintained in the records of the conference application 216. This can be used to indicate whether additional participants 124 have joined at a shared endpoint 108, or whether a participant 124 previously indicated as present has left the conference. The prompt can be delivered through an out of band channel to a device 108, 128.

Alternatively or in addition, the prompt can be delivered through an in-band channel to a device 108, 128, for example as a whisper or a DTMF tone recognized by the user interface provided by an app 252 or other application (e.g., a browser 256). The roster may also be automatically updated via GPS or wireless monitoring as a participant leaves the vicinity of the conference.

At step 432, a determination can be made as to whether the conference has ended. If the conference has not ended, the process can return to step 408, to check for additional user registrations and/or identifications. Alternatively, the process can end.

In accordance with embodiments of the present disclosure, users 124 can self-register with the conference system 104. In addition, a user 124 can be registered automatically or in a semi-automated fashion. For example, a user 124 can provide identifying information through a user device 128 carried by that user 124. Moreover, the identifying information can be pushed from the user device 128 in response to input from the user 124, and/or such information can be pulled from the user device 128 by the conference system 104 in conjunction with device detection and localization system 120. Moreover, such information can be provided through a unique identifier associated with the user device 128, or through identifying information that the conference system 104 can obtain from or correlate with the user device 128. In addition, a user 124 can identify other users 124 at the location of the identifying user 124. Accordingly, a roster or identification of users 124 at a shared communication device or endpoint 108 can be provided to the conference system 104. In this way, the accuracy of a roster can be increased.

In an additional embodiment, a policy might be instituted where only certain identified users 124 may perform user identification. In some situations, all users who have the conference room identifier may be allowed this privilege. In situations where more restriction is needed, a separate authentication code may be required.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A communication system, comprising:
a first shared communication device;
memory;
a processor;
a conference application stored on the memory and executed by the processor, wherein the conference application is operable to:
register a first user of the first shared communication device, wherein information identifying the first user is provided to the conference application by one of the first user and a first user communication device associated with the first user;
receive information identifying a second user of the first shared communication device, wherein the information identifying the second user of the first shared communication device is received from the first user of the first shared communication device.

2. The system of claim 1, further comprising:
a second shared communication device, wherein the information identifying the first and second users is output by the second shared communication device.

3. The system of claim 2, wherein the conference application is further operable to:
register a third user of the second shared communication device, wherein the information identifying the third user is provided to the conference application by one of the first registered user, the second registered user, and a fourth registered user.

4. The system of claim 3, wherein the information identifying the third user is provided to the conference application by a fourth registered user, wherein the fourth registered user is a user of the second shared communication device and is registered with the communication application.

5. The system of claim 1, wherein the information identifying the first user is provided to the conference application by the first user communication device.

6. The system of claim 5, wherein the information identifying the second user is received from the first user device.

7. The system of claim 6, wherein the first shared communication device is a communication endpoint for a real time communication carried over a first communication channel, wherein the memory and the processor are provided as part of a communication feature server, and wherein the first user device is in communication with the communication feature server using a second communication channel that is different than the first communication channel.

8. The system of claim 7, wherein the first user device includes an application that places the first user device in communication with the communication feature server over the first communication channel, and wherein the first user device is not an endpoint for the real time communication carried over the first communication channel.

9. A method for identifying a party using a shared communication endpoint that is participating in a communication session, comprising:
receiving information identifying a first user of a first shared communication device at a conference application;
receiving information from the identified first user identifying a second user at the conference application, wherein the second user is a user of one of the first shared communication endpoint and a second communication endpoint;
modifying a roster maintained by the conference application to include the information identifying the first and second users as active participants in a first communication session, wherein the first shared communication device is an endpoint for the first communication session.

10. The method of claim 9, wherein the second user is a user of the first shared communication device, wherein the information identifying the second user is received from the first user, and wherein the information identifying the second user received from the first user of the first shared communication device informs the conference application that the first shared communication device is shared by multiple users.

11. The method of claim 10, wherein the information identifying the first user is received from a first user device, and wherein the information identifying the second user of the first shared communication device is received from the first user device.

12. The method of claim 11, further comprising:
registering the first and second users of the first shared communication device with the conference application as being present in the first communication session.

13. The method of claim 12, wherein the first user is registered after receiving presence information for the first user, wherein the received presence information confirms that the first user is at a location of the first shared communication device, and wherein the second user is a user of the first shared communication device.

14. The method of claim 12, further comprising:
receiving additional information identifying the second user from a third user, and wherein the second user is registered after receiving the information identifying the second user from the first and third users.

15. The method of claim 14, wherein the third user is one of a user of the first shared communication device and a user of a second shared communication device.

16. The method of claim 11, wherein the second user is identified by name on a display of the first user device, and wherein the information identifying the second user received from the first user device is sent from the first user device to the conference application in response to a selection of the information identifying the second user by the first user.

17. The method of claim 16, further comprising:
after receiving the information identifying the second user, the conference application prompting the first user to confirm the continued participation of at least one of the first user and second user in the first communication session.

18. The method of claim 17, further comprising:
receiving information at the conference application indicating that one of the first and second users is no longer a participant in the communication session, modifying the roster to remove the at least one of the first and second users.

19. A tangible computer readable medium having stored thereon computer executable instructions, the computer executable instructions causing a processor to execute a method for identifying a user of a shared communication endpoint during a communication session, the computer readable instructions comprising:
instructions to receive information identifying at least a first participant in the communication session, wherein the information identifying the first participant indicates that the first participant is using a first shared communication endpoint, and wherein the information identifying the first participant is received from a first user device that is different than the first shared communication endpoint;
instructions to receiving information identifying at least a second participant in the communication session, wherein the information identifying the second participant indicates that the second participant is using the first shared communication endpoint, and wherein the information identifying the second participant includes information received from the first participant through the first user device;
instructions to include the first and second participants in a roster of participants in the communication session.

20. The tangible computer readable medium of claim 17, wherein the instructions further include:
instructions to provide a list of potential participants to a plurality of user devices, wherein the first user device and a second user device is included in the plurality of user devices;
instructions to assign a first confidence rating with the information identifying the second participant received from the first user device;
instructions to assign a second confidence rating with information identifying the second participant received from a second user device, wherein a confidence rating assigned to information is based on at least one of: a determined location of a user device providing the information, an identified owner of a user device providing the information, prompt one of the first and second first party is associated with a first communication device.
